(19) United States
(12) Patent Application Publication
(10) Pub. No.: US 2016/0238741 A1
(43) Pub. Date: Aug. 18, 2016

(54) SAPPHIRE SUBSTRATE AND LENS AND DISPLAY WITH THE SAPPHIRE SUBSTRATE

(71) Applicant: CRYSTALWISE TECHNOLOGY, HSINCHU (TW)

(72) Inventors: YEM-YEU CHANG, HSINCHU (TW); PEI-SHENG MA, HSINCHU (TW); YA-LENG CHEN, HSINCHU (TW)

(73) Assignee: CRYSTALWISE TECHNOLOGY, HSINCHU (TW)

(21) Appl. No.: 14/684,353

(22) Filed: Apr. 11, 2015

(30) Foreign Application Priority Data
Feb. 16, 2015 (TW) 104105306

(51) Int. Cl. G02B 1/118; G02B 3/08

(52) U.S. Cl. CPC G02B 1/118; G02B 3/08

(57) ABSTRACT

A sapphire substrate, of which transmittance is higher than 90%, includes two opposite surfaces, wherein at least one of the surfaces has a plurality of bumps thereon, and the surface roughness of the surface with the bumps is less than 100 nm. The distance between tops of two neighboring bumps is between 150 nm and 500 nm. Each of the bumps is higher than 60 nm. For each bump, the ratio of the height and the width of a bottom thereof connected to the corresponding surface is greater than 0.4. The sapphire substrate can be used in products such as all kinds of lens protective covers, panels, and smart phones.

### BACKGROUND OF THE INVENTION

1. Technical Field

The present invention relates generally to a sapphire substrate, and more particularly to an anti-reflective sapphire substrate.

2. Description of Related Art

The Mohs' hardness of sapphire crystal is 9, just next to diamond at 10 on Mohs Hardness Scale. Hence, sapphire crystal is much harder than ordinary glass, and is anti-scratch and wear resistant. With the advancement of the relevant manufacturing process, the manufacturing cost of sapphire materials gradually lowers, and therefore sapphire substrates can be further applied in various domains such as consumer electronics industry and optical industry.

However, though sapphire substrates are more anti-scratch than glass substrates, sapphire is a high reflective material, which means light tends to be reflected while being incident on a sapphire substrate. Because of this, transmittance of sapphire substrates may not be satisfactory to provide high image quality with consequent optical distortion.

To solve the problem, some manufactures coat an anti-reflective film on the surface of sapphire substrates to improve transmittance. Yet, anti-reflective films are not as hard as sapphire substrates, and easily get scratched. In the end, the overall appearance and image quality of a sapphire substrate are still affected with the scratches on the anti-reflective film coated thereon.

### BRIEF SUMMARY OF THE INVENTION

In view of the above, the primary objective of the present invention is to provide a sapphire substrate, which is anti-reflective, and improves the appearance and image quality.

The sapphire substrate provided in the present invention has transmittance higher than 90%, and has two opposite surfaces, wherein a plurality of bumps are formed on at least one of the surfaces; a distance between tops of two neighboring bumps is between 150 nm and 500 nm; a height of each of the bumps is higher than 60 nm; for each bump, the ratio of the height and a width of a bottom thereof connected to the corresponding surface is greater than 0.4.

The present invention further provides a camera lens, which includes a sapphire substrate and at least a lens arranged sequentially from an object side to an image sensor along an optical axis. The sapphire substrate has two opposite surfaces, wherein a plurality of bumps are formed on at least one of the surfaces; a distance between tops of two neighboring bumps is between 150 nm and 500 nm; a height of each of the bumps is higher than 60 nm; for each bump, the ratio of the height and a width of a bottom thereof connected to the corresponding surface is greater than 0.4.

The present invention further provides a display, which includes a sapphire substrate and a display panel. The sapphire substrate has two opposite surfaces, wherein a plurality of bumps are formed on at least one of the surfaces; a distance between tops of two neighboring bumps is between 150 nm and 500 nm; a height of each of the bumps is higher than 60 nm; for each bump, the ratio of the height and a width of a bottom thereof connected to the corresponding surface is greater than 0.4. The display panel has a display surface, wherein light emitted from the display surface passes through the sapphire substrate.

With the nanoscaled bumps formed on the sapphire substrate, the chances of reflecting incident light passing through the sapphire substrate is effectively lowered, which improves the anti-reflective property. Since sapphire already has high hardness, the sapphire substrate provided in the present invention is also anti-scratch and wear resistant at the same time.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a first preferred embodiment of the present invention;

FIG. 2 is a side view of the first preferred embodiment of the present invention;

FIGS. 3-9 are side views of the second to the eighth preferred embodiment of the present invention;

FIG. 10 is a sectional view showing the lens applied with the first preferred embodiment of the present invention;

FIG. 11 is a sectional view showing the inner surface of the sapphire substrate used in the lens is provided with the anti-reflective layer;

FIG. 12 is a sectional view showing the peripheral portion of the inner surface of the sapphire substrate used in the lens is provided with the additional functional or decorative coating;

FIG. 13 is a sectional view showing the inner surface of the sapphire substrate used in the lens is provided with the anti-reflective layer and the additional functional or decorative coating;

FIG. 14 is a sectional view showing the double-sided nano-structural anti-reflective layers of the sapphire substrate used in the lens is provided with the additional functional or decorative coating at the inner surface;

FIG. 15 is a sectional view showing a display applied with the first preferred embodiment of the present invention; and

FIG. 16 is a sectional view showing another display applied with the first preferred embodiment of the present invention.

### DETAILED DESCRIPTION OF THE INVENTION

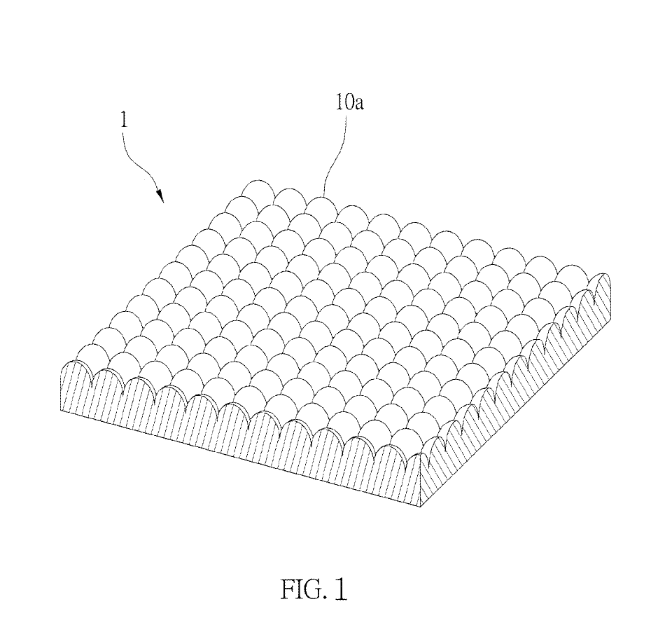

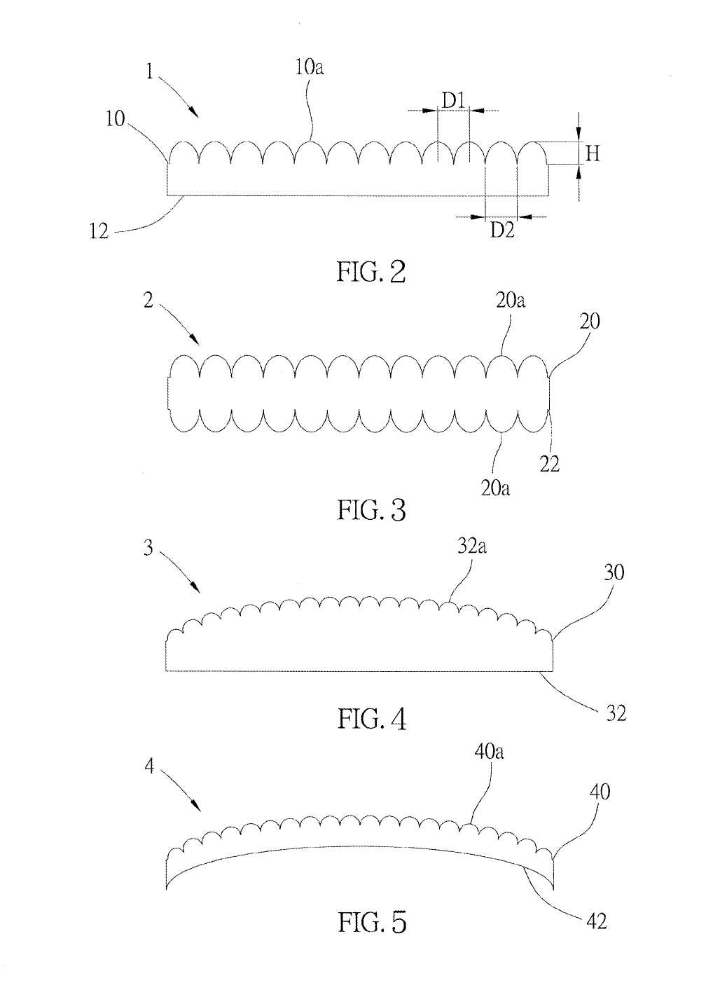

As shown in FIG. 1 and FIG. 2, a sapphire substrate 1 of the first preferred embodiment of the present invention is transparent, of which transmittance is higher than 90%. The sapphire substrate 1 has two opposite surfaces 10,12, wherein a plurality of hemispherical bumps 10a are formed on the surface 10 of the sapphire substrate 1.

The bumps 10a can be formed in one of the following ways: (1) using nanoimprint technology, such as nanoimprint lithography (NIL), step and flash imprinting lithography (SFIL), etc.; (2) using nanosphere lithography (NSL) technology; more specifically, a layer of solution mixed with nanospheres is coated on the surface 10 of the sapphire substrate 1 in advance, and then, with the self-assembling property of nanospheres, nanospheres are sequentially and periodically arranged on the surface 10 of the sapphire substrate 1. After that, nanospheres are used as etching masks in the process of etching and transferring; (3) using technology related to anodic aluminum oxide (AAO); in more details, during the anodic oxidizing process of metal aluminum, aluminum oxide self-assemblies to form nanopores, which can be used as the masking layer for etching and transferring; (4) using a nano-scaled polycrystalline film as a masking layer based on the different etching rate between grains and grain boundaries, the nano-scaled bumps will be formed after the etching process; (5) using a metal nano-particle coating as a shuttering layer; in more details, choosing a metal, which is poor wetting on the sapphire surface, and coating a nano-scaled discontinued film on the sapphire, the metal nano-particles will be formed by the dewetting process of thermal annealing. After that, nano-particles are used as etching masks in the process of etching and transferring.

The bumps 10a of the sapphire substrate 1 satisfy the following conditions:

1. The distance D1 between tops of each two neighboring bumps 10a is between 150 nm and 500 nm.

2. The height H of each bump 10a is greater than 60 nm.

3. For each bump 10a, the ratio of the height H and the width D2 of a bottom thereof connected to the surface 10 is greater than 0.4, wherein the ratio is preferable to be between 0.8 and 2.

4. The surface roughness of the surface 10 with the bumps 10a is less than 100 nm.

With the aforementioned conditions, the scale of the bumps 10a on the sapphire substrate 1 is smaller than the wavelength of incident light (the wavelength of visible light is around 390 nm to 780 nm). In this way, incident light with wavelength within this range would be less reflected while being incident on the sapphire substrate 1, and therefore such incident light would be able to successfully pass through the sapphire substrate 1, which improves the transmittance.

In the premise of satisfying the aforementioned conditions about the bumps, the present invention further provides sapphire substrates of several different embodiments. The second to the fourth preferred embodiments of the present invention are respectively shown in FIG. 3 to FIG. 5.

In the second preferred embodiment, two surfaces 20, 22 of a sapphire substrate 2 both have a plurality of bumps 20a formed thereon.

In the third preferred embodiment, one surface 30 of a sapphire substrate 3 is curved, while another surface 32 thereof is flat; a plurality of bumps 30a are formed on the curved surface 30.

In the fourth preferred embodiment, both surfaces 40, 42 of a sapphire substrate 4 are both curved, wherein the surface 40 is convex, while the surface 42 is concave; a plurality of bumps 40a are formed on the convex surface 40.

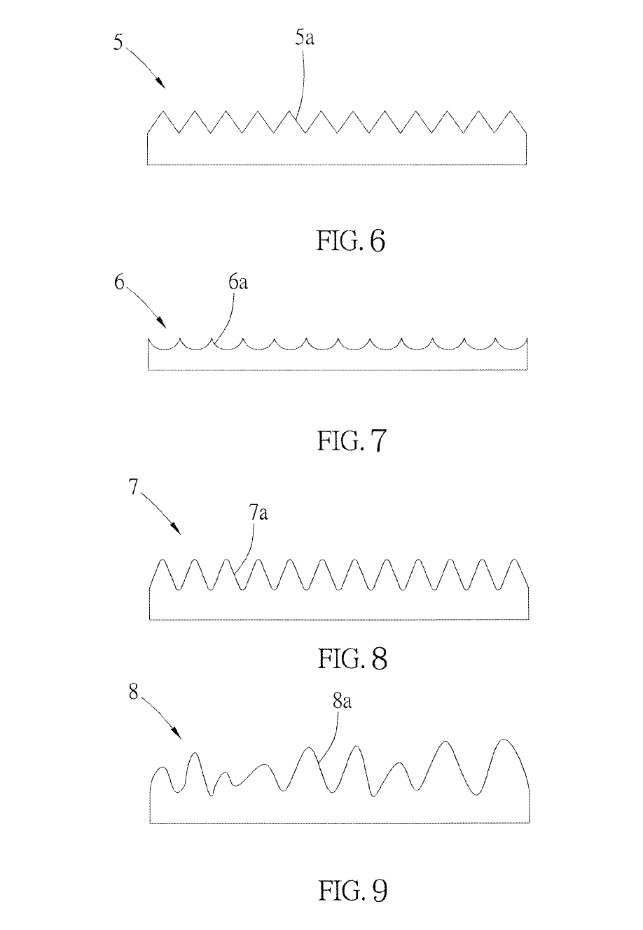

In addition, the fifth to the eighth preferred embodiments of the present invention are respectively shown in FIG. 6 to FIG. 9.

In the fifth preferred embodiment, bumps 5a of a sapphire substrate 5 are conical in shape.

In the sixth preferred embodiment, bumps 6a of a sapphire substrate 6 are tapered, wherein a side torus of each bump 6a is curved and depressed.

In the seventh preferred embodiment, bumps 7 of a sapphire substrate 7 resemble bamboo shoots, each of which has a narrower top and a wider bottom.

In the eighth preferred embodiment, bumps 8a of a sapphire substrate 8 are arranged randomly, wherein each of the bumps 8a does not necessary to have identical height, neither necessary to have identical width at a bottom thereof.

In summary, the sapphire substrates of the aforementioned embodiments are all able to improve the transmittance, and to reduce the chances of reflecting incident light.

It is worth mentioning that, the surface energy created by the nanoscaled bumps is extremely low, which prevents water stains or dust from adhering thereon, and therefore the sapphire substrates provided in the present invention are especially suitable for making lens protective covers of lens or panels.

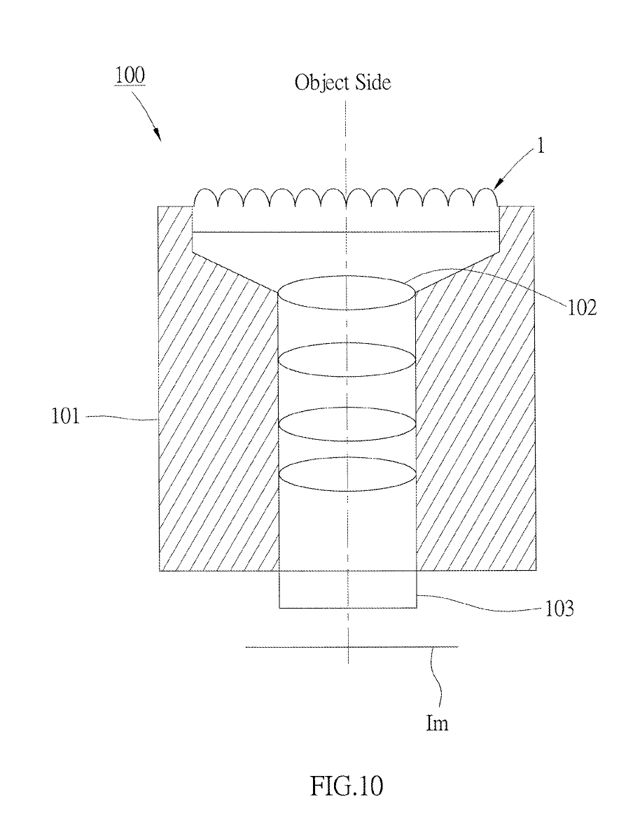

As shown in FIG. 10, a camera lens 100 which is applied with the sapphire substrate 1 provided in the present invention includes a case 101, wherein the case 101 accommodates a sapphire substrate 1 and four lenses 102 which are sequentially arranged from an object side to an image sensor Im along an optical axis.

The sapphire substrate 1 used in the camera lens 100 is the aforementioned sapphire substrate 1 of the first preferred embodiment of the present invention, and therefore the related details are not described herein. The lenses 102 can be all convex lenses, all concave lenses, or combinations of convex and concave lenses to satisfy different optical requirements, which makes the camera lens 100 generate corresponding optical effects, such as the effects of fisheye lens, wide angle lens, reflex lens, tilt-shift lens, micro lens, telephoto lens, teleconverter lens. In addition, a photosensitive member 103 is provided behind the lenses 102 along the optical axis to convert optical images captured by the camera lens 100 into electrical signals, wherein the photosensitive member 103 can be selected from CCD (charge-coupled Device) or CMOS (complementary metal-oxide-semiconductor).

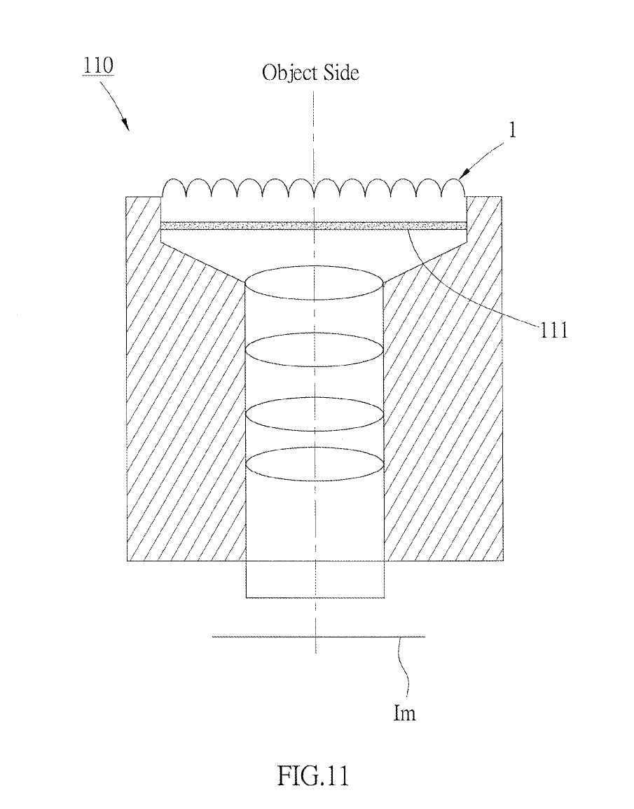

A camera lens 110 shown in FIG. 11 is designed based on the aforementioned camera lens 100, wherein an anti-reflective layer 111 is coated on an inner surface (the surface which does not directly contact with the outside air) of the sapphire substrate 1. The anti-reflective layer 111 can be an anti-reflective coating formed through the manufacturing process of coating multilayer films, which may further reduce the reflectance. The anti-reflective layer 111 could also provide a function of infrared filter.

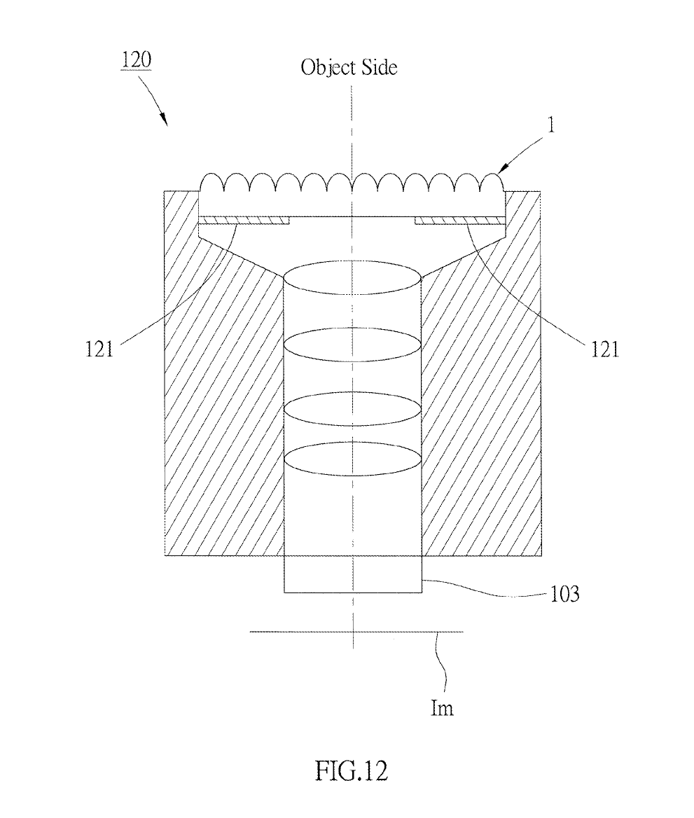

A camera lens 120 shown in FIG. 12 is also designed based on the aforementioned camera lens 100, wherein a coating 121 is provided on a peripheral portion of an inner surface of the sapphire substrate 1. The coating 121 can be made through the manufacturing process of printing or laminating. Furthermore, the coating 121 can be used for decorative purpose and/or for limiting light, depending on the requirements of manufacturers.

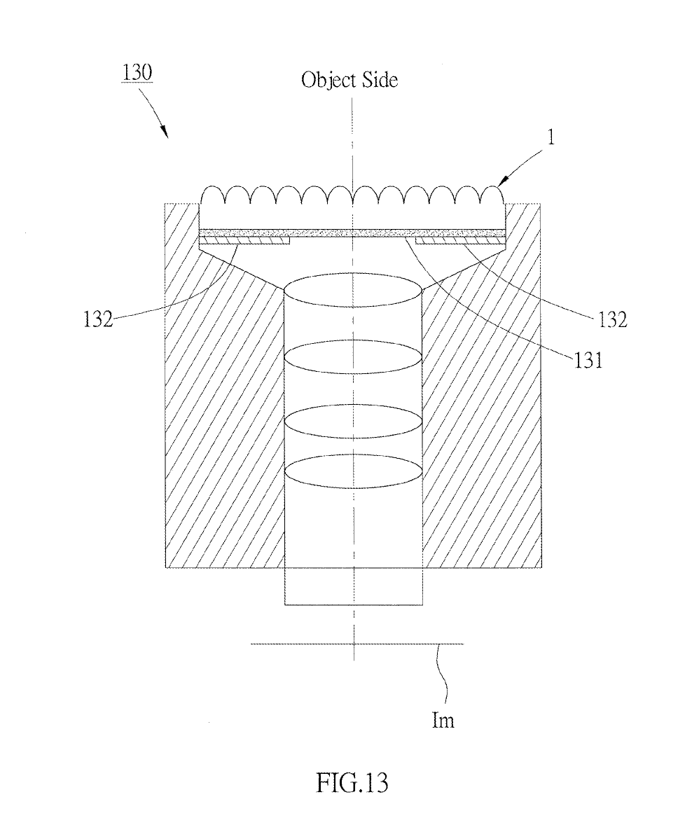

Similarly, a camera lens 130 shown in FIG. 13 is designed based on the aforementioned camera lens 100, wherein an anti-reflective layer 131 is coated on an inner surface of the sapphire substrate 1, in addition, coating 132 is further provided on a peripheral portion of a surface of the anti-reflective layer 131. The coating 132 can be used for decorative purpose and/or for liming light. The anti-reflective layer 131 could also provide a function of infrared filter.

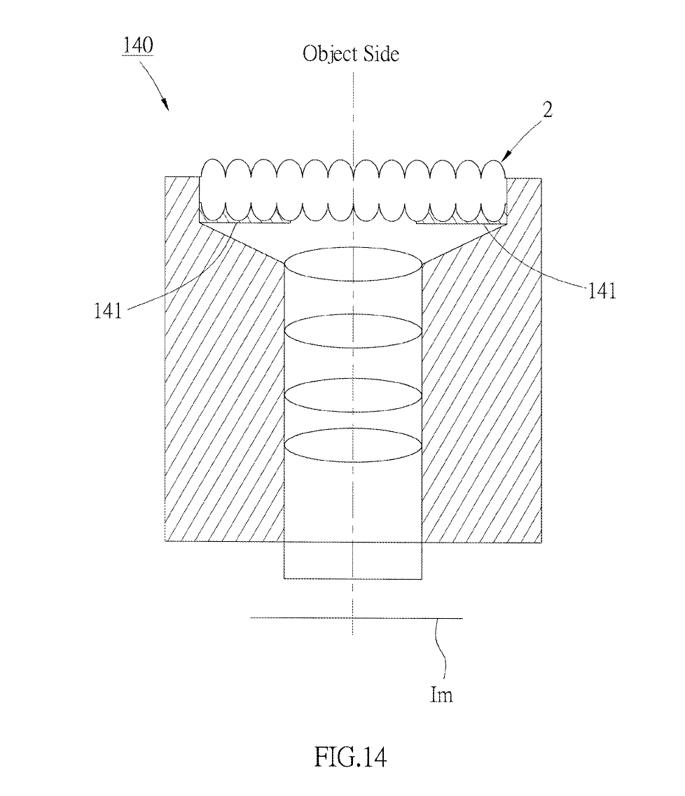

Again, a camera lens 140 shown in FIG. 14 is designed based on the aforementioned camera lens 100, wherein the protective cover (i.e. the sapphire substrate 1) of the aforementioned camera lens 100 is replaced by the sapphire substrate 2 described above as the second preferred embodiment of the present invention. An inner surface of the sapphire substrate 2 is coated with a coating 141, which can be used for decorative purpose and/or for limiting light.

It should be noted that, though the aforementioned camera lenses 100, 110-140 all include four lenses, the number of the lenses is not a limitation of the present invention. In other embodiments, a camera lens can, of course, have any number of lenses depending to different requirements.

A display 200 shown in FIG. 15 includes a case 201, a sapphire substrate 1, and a display panel 202. The case 201 has an opening, and the sapphire substrate 1 is provided on the case 201 to seal the opening. The sapphire substrate 1 is the sapphire substrate 1 described above as the first preferred embodiment of the present invention, and therefore the related details are not described herein. The display panel 202 is provided in the case 201, wherein the display panel 202 has a display surface 202a facing the opening of the case 201 sealed by the sapphire substrate 1, and the light emitted from the display surface 202a passes through the sapphire substrate 1. In practice, a touch control unit can be included in the display 200 between the sapphire substrate 1 and the display panel 202.

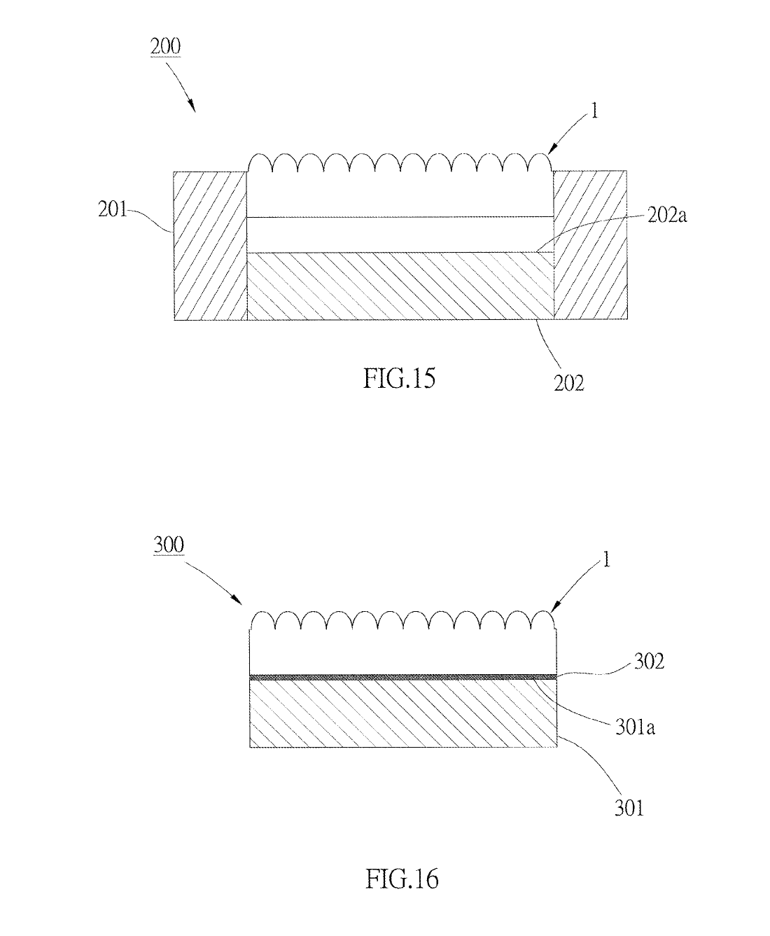

Another display 300 shown in FIG. 16 includes a sapphire substrate 1 and a display panel 301, wherein the sapphire substrate 1 is, again, the sapphire substrate 1 described above as the first preferred embodiment of the present invention, and therefore the related details are not described herein. The display panel 301 has a display surface 301a, and the sapphire substrate 1 is affixed on the display surface 301a of the display panel 301 though a layer of optical clear adhesive 302, wherein the light emitted from the display surface passes through the sapphire substrate 1. In practice, the display panel 301 can be a touch panel.

It should be noted that, the sapphire substrate used in the aforementioned camera lens 100, 110-130, and the displays 200, 300 is not necessary to be the sapphire substrate 1 of the first preferred embodiment of the present invention, other sapphire substrates 2-8 of other preferred embodiments can be selected depending on different requirements.

In addition, an anti-reflective layer (e.g., an anti-reflective coating) can be further coated on an inner surface of the sapphire substrate 1 of the displays 200, 300 to reduce the reflectance. In practice, coatings for decorative purpose, for limiting light, for filtering light, or for shielding can be also selected to be provided thereon to optimize the optical performance.

In summary, with the bumps formed on the surfaces of the sapphire substrates provided in the present invention, chances of reflecting incident light passing through a sapphire substrate can be effectively reduced. As a result, anti-reflective effect is improved, and transmittance of a sapphire substrate is enhanced. The sapphire substrates provided in the present invention can have transmittance higher than 90% for visible light, and therefore are able to provide high image quality. In this way, an additional anti-reflective film would not be necessary to be coated on the surface of a sapphire substrate, which gets rid of the problem of leaving scratches or causing abrasion on an anti-reflective film and affecting the appearance of the sapphire substrate.

It must be pointed out that the embodiments described above are only some preferred embodiments of the present invention. All equivalent structures which employ the concepts disclosed in this specification and the appended claims, such as forming bumps on a concave surface of a sapphire substrate, or forming bumps on a flat surface and on a concave surface of a sapphire substrate at the same time, should fall within the scope of the present invention.

What is claimed is:

1. An anti-reflective sapphire substrate, of which transmittance is higher than 90%, characterized in that:
the sapphire substrate has two opposite surfaces, wherein a plurality of bumps are formed on at least one of the surfaces; a distance between tops of two neighboring bumps is between 150 nm and 500 nm; a height of each of the bumps is higher than 60 nm; for each bump, the ratio of the height and a width of a bottom thereof connected to the corresponding surface is greater than 0.4.

2. The anti-reflective sapphire substrate of claim 1, wherein at least one surface of the sapphire substrate is curved, and the bumps are formed on the curved surface.

3. The anti-reflective sapphire substrate of claim 1, wherein surface roughness of the surface with the bumps is less than 100 nm.

4. The anti-reflective sapphire substrate of claim 1, wherein the ratio of height and the width of the bottom of each of the bumps is between 0.8 and 2.

5. The anti-reflective sapphire substrate of claim 1, wherein the bumps are conical, tapered, or hemispherical in shape.

6. The anti-reflective sapphire substrate of claim 1, wherein the bumps are arranged randomly.

7. The anti-reflective sapphire substrate of claim 1, wherein transmittance of the sapphire substrate is higher than 90% for visible light.

8. A camera lens, comprising a sapphire substrate and at least a lens arranged sequentially from an object side to an image sensor along an optical axis, characterized in that:
the sapphire substrate has two opposite surfaces, wherein a plurality of bumps are formed on at least one of the surfaces; a distance between tops of two neighboring bumps is between 150 nm and 500 nm; a height of each of the bumps is higher than 60 nm; for each bump, the ratio of the height and a width of a bottom thereof connected to the corresponding surface is greater than 0.4.

9. A display, comprising:
a sapphire substrate having two opposite surfaces, wherein a plurality of bumps are formed on at least one of the surfaces; a distance between tops of two neighboring bumps is between 150 nm and 500 nm; a height of each of the bumps is higher than 60 nm; for each bump, the ratio of the height and a width of a bottom thereof connected to the corresponding surface is greater than 0.4; and
a display panel having a display surface, wherein light emitted from the display surface passes through the sapphire substrate.
